(19) United States
(12) Patent Application Publication
(10) Pub. No.: US 2011/0077907 A1
(43) Pub. Date: Mar. 31, 2011

(54) SIGNAL-LEVEL DETERMINING DEVICE AND METHOD

(76) Inventor: Wieslaw Jerzy Szajnowski, Guildford (GB)

(21) Appl. No.: 12/993,718

(22) PCT Filed: May 19, 2009
(86) PCT No.: PCT/EP09/56062

§ 371 Date: Nov. 19, 2010

(30) Foreign Application Priority Data
May 20, 2008 (GB) 0809168.8

(51) Int. Cl. G06F 17/18

(52) U.S. Cl. 702/179

(57) ABSTRACT

An apparatus and method is disclosed for robustly detecting a signal in the presence of background noise which includes impulsive noise. Each value of a signal is mapped to a point on a semicircle defined by two coordinates on orthogonal axes in two-dimensional space. A respective mean is calculated of each of the two coordinates of the transformed points, and the two means are used to calculate a mean direction of the points on the semicircle. The mean direction is reverse-mapped back into the signal domain and compared against a detection threshold. The detection threshold may be set in dependence upon the concentration of the points on the semicircle.

### FIELD OF THE INVENTION

The present invention relates to a method and apparatus for determining the level of a signal corrupted by background noise and impulsive interference, and is particularly, but not exclusively, well suited to detecting a signal reflected from a small object in the presence of interfering signals backscattered by the dynamically disturbed sea surface.

### BACKGROUND OF THE INVENTION

In many practical applications, a signal of interest is corrupted by a mixture of noise with essentially Gaussian characteristics (e.g., thermal noise) and interference of impulsive nature. The probability distribution of such combination will often exhibit so-called ‘heavy’ tails, and various statistical models have been developed to characterize non-Gaussian phenomena. For example, the magnitude of a microwave signal reflected from the sea surface is often characterized in terms of Weibull, log-normal or K distribution.

Microwave sensors operating in a maritime environment are expected to reliably detect various small objects of potential interest in the presence of unwanted signals reflected from the sea surface, often referred to as sea clutter. Small objects to be detected include boats and rafts, buoys, various debris and small fragments of icebergs. Some of those objects may pose a significant threat to safe ship navigation, whereas other objects are of interest in search-and-rescue missions, coastal surveillance, homeland security etc.

Non-Gaussian sea clutter can negatively affect the detection performance of many sensors, often designed for optimum operation in Gaussian noise. Accordingly, over the many years, different solutions have been offered to the problem of detecting small signals in sea clutter.

A representative example of a practical non-coherent system capable of detecting objects in sea clutter is presented in U.S. Pat. No. 7,286,079, 23 Oct. 2007: Method and Apparatus for Detecting Slow-Moving Targets in High-Resolution Sea Clutter.

In accordance with the above disclosure, a comparator is used to convert radar returns from each range cell into a stream of binary data. If a reflected signal exceeds a predetermined threshold, the signal is represented by a binary ‘one’; otherwise, the signal is represented by a binary ‘zero’. This operation is depicted schematically in FIG. 1. One drawback of such a ‘hard’ decision is evident: signals slightly below the threshold are discarded although they could affect a global detection decision, and therefore useful information is being ignored.

Next, a range-extent filter processes the binary data to indicate the presence of clusters comprising ‘ones’ that appear in adjacent range cells. These clusters are regarded as being indicative of a presence of an object extended in range. FIG. 2 illustrates the operation of a range-extent filtering. However, if such filter is to be efficient, the extent of a hypothetical object must be known a priori. Furthermore, no range-extent filtering is applicable to objects so small as to occupy a single range cell.

Finally, persistence in time of a hypothetical object is examined over a predetermined time interval. Object detection is declared if the output of a suitable persistence integrator exceeds a preselected threshold. This operation is depicted schematically in FIG. 3. Unfortunately, integration in time cannot recreate information lost in the process of thresholding or hard-limiting.

The detection performance of the above system is analyzed in more detail in: S. D. Blunt, K. Gerlach and J. Heyer, “HRR Detector for Slow-Moving Targets in Sea Clutter”, IEEE Transactions on Aerospace and Electronic Systems, vol. 43, July 2007, pp. 965-975. This publication discusses the relevant theoretical background, and also various assumptions and simplifications leading to a practical implementation of the detector.

For example, it is shown that the step-like characteristic of a comparator employed by the detector is only a convenient and practical approximation of an optimal non-linear characteristic obtained from a theoretical analysis. Furthermore, it appears that combining the observations in FIG. 1a in a linear manner (as in arithmetic mean) and comparing the result with a threshold does not result in a robust detection procedure required for backgrounds that exhibit noise of impulsive nature.

It would therefore be desirable to provide a method and an apparatus for determining the level of a corrupted signal in a nonlinear and robust manner.

In particular, it would be desirable, but not essential, for this method and apparatus to be able to detect small objects in spiky sea clutter in a more efficient way than that provided by the prior art techniques.

### SUMMARY OF THE INVENTION

According to the present invention, there is provided a method of processing signal values to determine a level of the signal values, the method comprising a signal processor performing processes of:

mapping each of a plurality of signal values to a respective point on an arc of at least part of a circle;

using the values of at least one of the coordinates defining the points to determine a mean value; and

determining whether the signal values exceed a threshold by:
comparing the mean value with a threshold value; or
reverse-mapping the mean value to a value in the domain of the signal values, and comparing the reverse-mapped value with a threshold value.

By determining the mean value in this way, the present inventor has found that the mean value is a more robust estimator of the signal level because the mean value is much less affected by one or more large signal values (such as a large value resulting from an impulse noise spike) than other types of mean (for example arithmetic mean).

As a result, the detection of signals in a noisy background with impulsive noise can be improved.

The present invention further provides apparatus for performing the method above.

### DESCRIPTION OF THE DRAWINGS

FIG. 1 depicts a prior art use of a comparator to convert radar returns from each range cell into a stream of binary data.

FIG. 2 illustrates a prior art operation of a range-extent filter performed on the binary data to indicate the presence of clusters.

FIG. 3 illustrates a prior art operation of a persistent integrator.

FIG. 4 shows the steps of determining the circular mean in accordance with an embodiment of the invention.

FIG. 5 is a functional block diagram of a circular-mean calculator CMC constructed in accordance with an embodiment of the invention.

FIG. 5 is a functional block diagram of a circular-mean calculator CMC constructed in accordance with a second embodiment of the invention.

FIG. 7a depicts two mapping functions constructed in accordance with a third embodiment of the invention.

FIG. 7b shows the transformation of signal values into angular positions.

FIG. 7c depicts the mapping of signal values onto a unit semicircle

FIG. 8 is a functional block diagram of a modified circular-mean calculator MCMC constructed in accordance with the third embodiment of the invention.

FIG. 9 depicts decision regions when both the circular mean CM and the circular concentration DC are utilized for signal detection.

FIG. 10 is a functional block diagram of a signal detecting system SDT incorporating a circular-mean calculator CMC constructed in accordance with a fourth embodiment of the invention.

### EMBODIMENTS

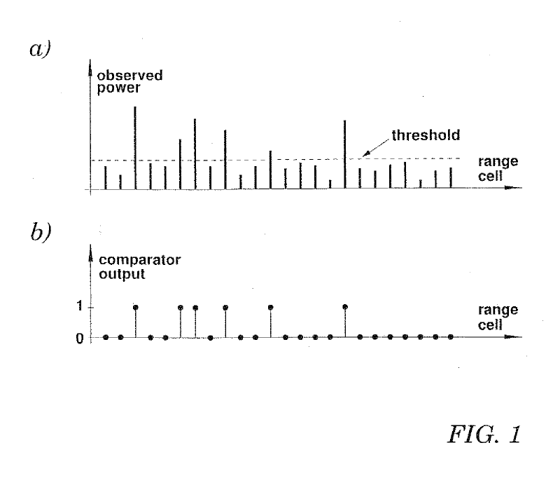

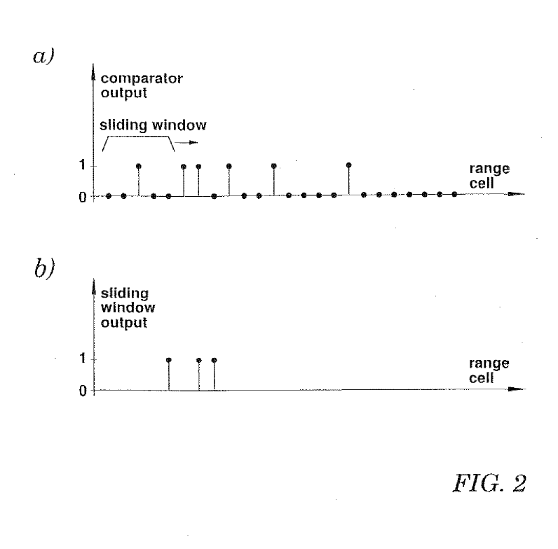

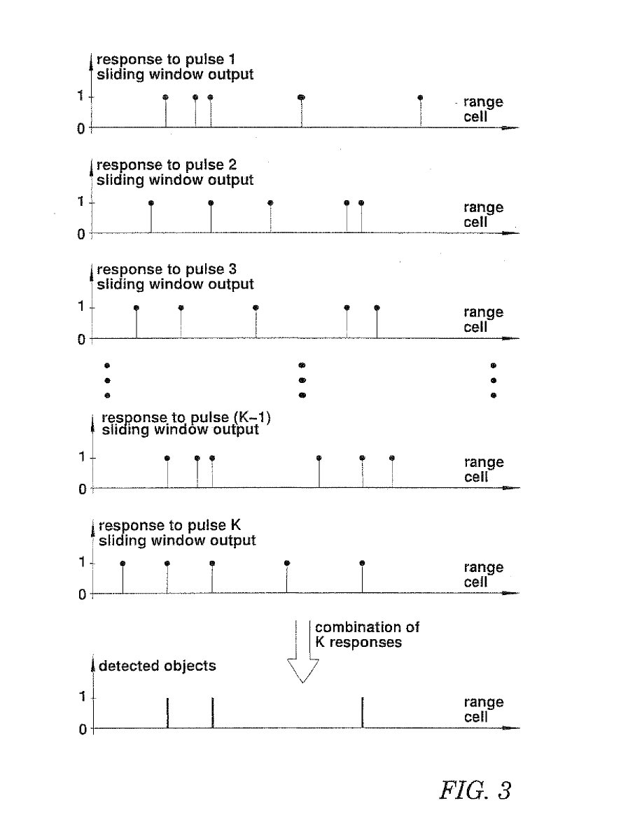

An analysis of signal detection in impulsive noise has shown that utilizing a conventional arithmetic mean as a measure of signal values such as those shown in FIG. 1a to compare against a detection threshold cannot provide an optimum detection performance. Therefore, an improved and robust method is needed to determine the signal level in a way more suitable for signal detection.

In accordance with embodiments of the invention, each value p of a set of observed values of a signal (e.g., envelope, magnitude or power) is transformed to a point in two-dimensional space which has two coordinates on orthogonal axes (x,y) defining a position on an arc of a circle. The arc subtends an angle which is less than, or equal to, 180° (or the equivalent in other units). Preferably, the arc is that of a semicircle. A respective mean is calculated separately for the x coordinates and the y coordinates of the transformed points. The two resulting means are then used to calculate a mean direction θ_{MD} of the transformed points in the two-dimensional space. This mean direction θ_{MD} is then used to compare the observed signal values against a threshold. In a first technique, this comparison is performed by applying a reverse transform M⁻¹ to map the mean direction θ_{MD} back into the signal domain of the observed values, to give what is termed herein a circular mean p_{CM}, and then comparing the circular mean with a threshold value in the signal domain. In a second, alternative but equivalent, technique, the comparison is performed by comparing the mean direction θ_{MD} with a threshold value in the two-dimensional space of the semicircle. This threshold value may be defined in that two-dimensional space at the outset or it may be defined in the signal domain of the observed values and transformed into the two-dimensional space of the semicircle using the same transformation as that used to transform the signal values.

In an alternative embodiment, each value of the set of observed values p of the signal is transformed to a point on an arc of a circle in two-dimensional space. A mean is calculated of the values of one of the two coordinates x,y (but not both). This mean is then used to compare the observed signal values against a threshold using one of the two techniques set out above.

### First Embodiment

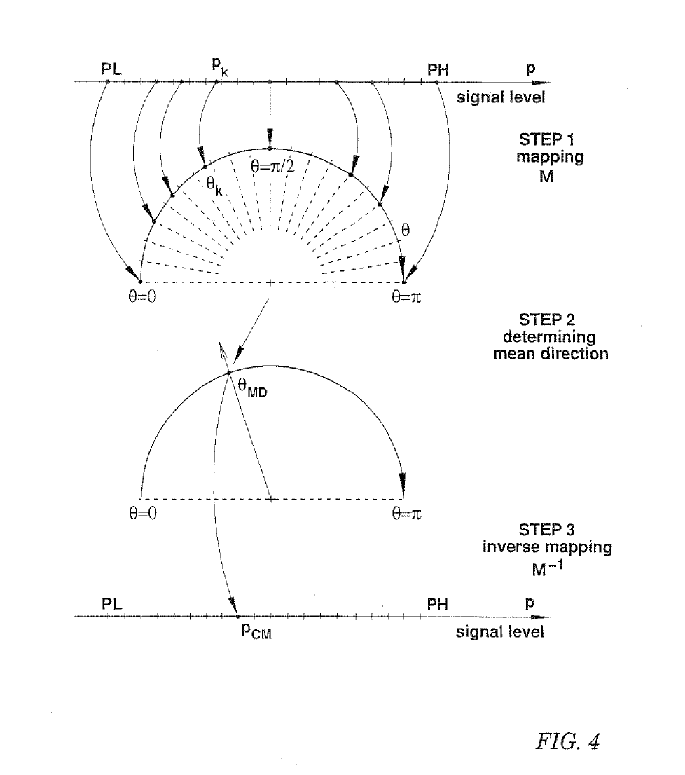

In accordance with a first embodiment of the invention, a circular mean p_{CM} is calculated by applying a procedure comprising the following three steps (which are also schematically illustrated in FIG. 4):

Step 1—Observed values p of a signal mapped onto a unit semicircle with the use of a mapping function M(p). As a result, each value pₖ from a predetermined range (PL, PH) of interest will be represented by a corresponding point placed on a unit semicircle at angular position θₖ.

Accordingly, K observed values of a signal

{pₖ}={p₁,p₂, . . . , p_{K-1},p_{K}}; pₖ∈(PL,PH)

will be represented by a corresponding set of K angles

{θₖ}={θ₁,θ₂, . . . , θ_{K-1},θ_{K}}; θₖ∈(α,α+π)

where α is an arbitrary initial angle.

Step 2—To determine the x and y coordinates of each mapped point pₖ in the two-dimensional space of the semicircle, the sines and cosines of the angles {θₖ} are calculated. The calculated values are then averaged separately to obtain two respective means:

$${Y}_{K} = \frac{1}{K} {\sum }_{k = 1}^{K} sin {θ}_{k} ; {X}_{K} = \frac{1}{K} {\sum }_{k = 1}^{K} cos {θ}_{k}$$

Then, the mean direction θ_{MD} of the set of angles is obtained from

θ_{MD}=tan⁻¹(Y_{K}/M_{K})

Step 3—The circular mean p_{CM} of the underlying set of K signal values

{pₖ}={p₁,p₂, . . . , p_{K-1},p_{K}}; p_{K}∈(PL,PH)

is obtained by applying an inverse mapping M⁻¹(θ) to the mean direction θ_{MD} to transform it back into the signal domain of the observed signal values p. Subsequently, the circular mean p_{cm} is compared to a threshold value in the signal domain (or, alternatively, the mean direction θ_{MD} is compared with a threshold value in the two-dimensional space of the semicircle).

FIG. 4 illustrates schematically the procedure of determining a circular mean p_{CM} of a given set of signal values. Although in this case, the semicircle shown appears in the first two quadrants (hence, α=0), this particular feature is not essential.

In order to facilitate the understanding of the first embodiment and its advantages, a simple illustrative example is given below.

The first step is to transform the measured values of p to values p* that fall into a (0, 180) degree interval. Suppose that the measured values of p are:

p₁=p₂=p₃=p₄=p₅=260; p₆=500

A linear shifting operation then subtracts 200 from each value to give:

p₁ₛ=p₂ₛ=p₂ₛ=p₄ₛ=p₅ₛ=60; p₆ₛ=300

A linear scaling operation then divides each value by 2 to give:

p₁*=p₂*= . . . =p₅*=30; p₆*=150

These transformed values p* of the signal values p now fall into a (0,180)-interval. The transformed signal values p* and their corresponding angular position θ, expressed in degrees, have equal numerical values.

It should be noted that this method for shifting and scaling the data is just one example of many methods that can be used for this operation.

The arithmetic mean p_{AM} of the above set of transformed values, p*, is

p_{AM}=(5×30+150)/6=50

As seen, the single relatively large observation p₆*=150 (e.g., an interfering noise spike) shifts the mean (30) of the remaining five observations, p₁*-p₅*, in a significant manner.

In the second step of processing in this embodiment, the mean direction θ_{MD} of the transformed values, p₁*-p₆*, is determined from

$${Y}_{6} = ( 5 \times sin 30 ° + sin 150 ° ) / 6 = 1 / 2$$

$${X}_{6} = ( 5 \times cos 30 ° + cos 150 ° ) / 6 = \sqrt{3} / 3$$

$${θ}_{MD} = {tan}^{- 1} ( \frac{\sqrt{3}}{2} ) \approx 41 °$$

Hence, the mean direction θ_{MD} of the observed values is equal to 41, whereas the arithmetic mean p_{AM} in the circular domain was equal to 50. As will be understood, the mean direction θ_{MD} is a more robust estimator of the mean level of the values p, because it is much less affected by a single larger observation (namely p₆*).

In the third step of the processing, the present embodiment transforms the mean direction θ_{MD}=41° back to the same domain as the measured signals p using an inverse mapping M⁻¹.

Therefore, the transformed value p_{CM}=(41×2)+200=282.

On the other hand, the arithmetic mean of the signal values p in the signal domain is [(5×260)+500]/6=300.

Accordingly, the circular mean p_{CM} produced by the present embodiment is a more robust indication of the mean level of the values p in the signal domain than the conventional arithmetic mean. This is because the value of the circular mean p_{CM} is less effected by the spurious value p₆ than the arithmetic mean.

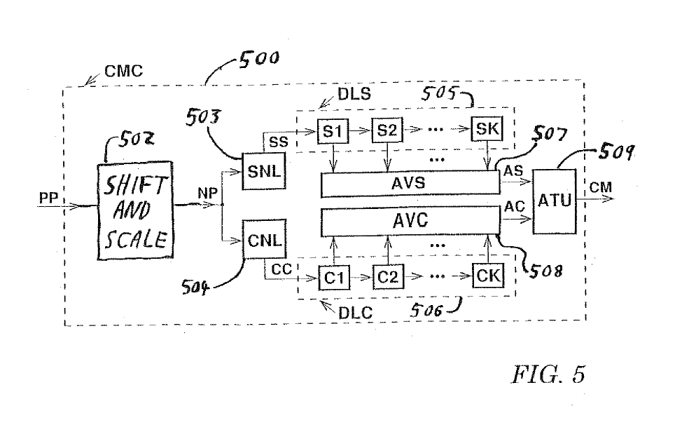

An apparatus for performing the above calculation of p_{CM} is shown in FIG. 5.

The calculator shown in FIG. 5 comprises the following functional units:
a shift and scale unit 502;
two nonlinear converters, SNL 503 and CNL 504;
two tapped delay lines, DLS 505 and DLC 506;
two averaging circuits, AVS 507 and AVC 508;
an arithmetic unit ATU 509.

A positive input signal PP, such as envelope, magnitude or power, is passed through the sift and scale unit 502 which maps each value of the input signal to a value within a range of values with a span of 180, thereby generating a normalized signal NP.

The normalized signal level NP is applied in a parallel fashion to the two nonlinear converters, SNL 503 and CNL 504. The outputs, SS and CC, of the converters are obtained from the common input NP by utilizing two suitably selected mapping functions; in the considered case

SS=sin NP, CC=cos NP

As described previously, the values SS and CC define the x and y coordinates of the value NP in two-dimensional space.

The signals SS and CC propagate along their respective tapped delay lines, DLS 505 and DLC 506: K samples of the signal SS are available at the outputs of delay cells, S1, S2, . . . , SK, whereas K samples of the signal CC are available at the outputs of delay cells, C1, C2, . . . , CK.

The averaging circuit AVE 507 produces at its output a value AS proportional to the sum of its inputs obtained from the cells S1, S2, . . . , SK. Similarly, the averaging circuit AVC 508 produces at its output a value AC proportional to the sum of its inputs obtained from the cells C1, . . . , C2, CK. These two values, AS and AC, are utilized by the arithmetic unit ATU 509 to determine a circular mean CM.

The calculated circular mean CM is then compared against a threshold value in a comparison unit (not shown in FIG. 5).

### Second Embodiment

In the first embodiment described above, signal values p were transformed into angle values θ by employing a linear operation of the ‘shift-and-scale’ type. However, in practical applications, it may be advantageous to apply first a nonlinear (e.g., logarithmic) transformation to the observed signal values in order to adjust their dynamic range non-linearly, and then map such transformed data onto a unit semicircle. An embodiment which performs such processing is described below.

For example, a useful nonlinear mapping is of the form

θₖ=H(γ log₁₀ p)

where the clipper function H(•) limits the minimum and maximum values of its argument to −π/2 and π/2, respectively; γ is a scaling factor used to further adjust the dynamic range of the signal being processed.

For example, if the range of observed values p extends from 0.01 to 100, then a γ=π/4 would place all values of p within (−π/2, π/2), with values lying on both of the extremities. If a new value of p was subsequently detected that fell outside of the 0.01 to 100 range, then, in order for the same value of γ to be used for the new p value, the clipper function H would be required to limit the new mapped value of p to the (−π/2, π/2) range. In practice, if the p values mostly fell within the 0.01 to 100 range, and rarely were at or beyond these limits, then the clipper function H would not usually be utilised.

Applying a logarithmic transformation prior to mapping onto a semicircle may be preferred to using other nonlinear transformations for the following reasons:
1. A logarithmic transformation, being compressive, suppresses larger observations.
2. Scale parameter of underlying data is converted into a shift parameter thereby simplifying operation of signal normalization because division will be conveniently reduced to simple subtraction.

FIG. 6 is a functional block diagram of a circular-mean calculator CMC constructed in accordance with the second embodiment of the invention.

The calculator comprises the following functional units:
a logarithmic converter LGI 601;
a subtractor SET 602;
two nonlinear converters, SNL 503 and CNL 504;
two tapped delay lines, ELS 505 and DLC 506;
two averaging circuits, AVS 507 and AVC 508;
an arithmetic unit ATU 609.

Accordingly, compared with the calculator shown in FIG. 5 of the first embodiment, the logarithmic converter LGI 601 and the subtractor SET 602 replace the shift and scale unit 502. All of the other components remain the same, with the exception of ATU 609, which performs a different reverse mapping M⁻¹ compared to the first embodiment to take account of the log operation performed on p.

A positive input signal PP, such as envelope, magnitude or power, is passed through the logarithmic converter LGI 601 to produce a signal LP being a logarithmic measure of the level of the input signal PP, hence

LP=log₁₀ PP

The signal LP is then normalized in the subtractor SET 602 by subtracting from the signal LP a logarithm EL of some reference level BG of interest

$$NP = LP - BL = {log}_{10} PP - {log}_{10} BG = {log}_{10} ( \frac{PP}{BG} )$$

For example, in signal detection problems, the reference level may be the average level of background noise, obtained from long-term observations. The action of subtracting the value EL from LP maps the value of LP to a point on a unit semicircle having an angular range (−π/2, π/2). It is equivalent to the scaling provided by the factor γ.

The normalized signal level NP is applied in a parallel fashion to the two nonlinear converters, SNL 503 and CNL 504. The outputs, SS and CC, of the converters are obtained from the common input NP by utilizing two suitably selected mapping functions; in the present embodiment

SS=sin NP, CC=cos NP

The signals SS and CC propagate along their respective tapped delay lines, DLS 505 and DLC 506: K samples of the signal SE are available at the outputs of delay cells, S1, S2, . . . , SK, whereas K samples of the signal CC are available at the outputs of delay cells, C1, C2, . . . , CK.

The averaging circuit AVS 507 produces at its output a value AS proportional to the sum of its inputs obtained from the cells S1, S2, . . . , SK. Similarly, the averaging circuit AVC 508 produces at its output a value AC proportional to the sum of its inputs obtained from the cells C1, C2, . . . , CK. These two values, AS and AC, are utilized by the arithmetic unit ATU 609 to determine a circular mean CM.

The calculated circular mean is then compared against a threshold value in a comparison unit (not shown in FIG. 6).

### Third Embodiment

In the above embodiments, a signal value p is mapped to a point on unit semicircle and then trigonometric operators are applied to determine the two coordinates in the two-dimensional space of the semicircle which define the position of the point. These coordinates are then used to calculate the mean direction θ_{MD} and, if required, the circular mean p_{CM}. However, the initial mapping of the signal value p onto the semicircle may be performed in such a way that the mapping directly gives the two coordinates of the resulting point an the semicircle. Accordingly, it is then not necessary to calculate the coordinates by performing the trigonometric operations of the first and second embodiments.

An embodiment which performs such processing is described below.

In general, the mapping of a signal value p to a semicircle can be performed with the use of two mapping functions, S(p) and C(p), constructed in a suitable manner. Because the mapping is required to produce a semicircle, the mapping functions must satisfy the condition

S²(p)+C²(p)=b

where b is a constant. In the case of a unit semicircle b=1.

In accordance with the third embodiment of the invention, a first mapping function S(p) is to be a monotonically increasing continuous function: it assumes its minimum value, −1, for the smallest signal level PL, and reaches its maximum equal to +1 at the largest signal level PH. There are infinitely many such functions, and a suitably selected segment of a sinewave is one of the many choices; another useful function will be discussed in the following.

Next, a second mapping function C(p) is obtained from the mapping function S(p) as follows

C(p)=\sqrt{1−S²(p)}

Hence, the mapping operation M[S(p),C(p)], utilizing two mapping functions, S(p) and C(p), may be viewed as a non-linear transformation of a one-dimensional p-space into a two-dimensional (S,C)-space. Each signal value p is consequently mapped directly to a point on a unit semicircle, such that one coordinate of the point is defined by S(p) and the other coordinate of the point is defined by C(p). An arithmetic average can then be applied directly to S(p) and C(p) to obtain the parameters for the mean direction.

More particularly, the mean direction θ_{MD} is calculated from

$${Y}_{K} = \frac{1}{K} {\sum }_{k = 1}^{K} S ( {p}_{k} ) ; {X}_{K} = \frac{1}{K} {\sum }_{k = 1}^{K} C ( {p}_{k} )$$

$${θ}_{MD} = {tan}^{- 1} ( {Y}_{k} / {X}_{K} )$$

Then, the mean direction θ_{MD} can be compared to a threshold value. Alternatively, if required, the circular mean p_{CM} of the signal values p is found by applying an inverse mapping M⁻¹(θ) to the mean direction θ_{MD}, and the circular mean p_{CM} is compared against a threshold. The inverse mapping M⁻¹ can be determined either by calculating and evaluating the mathematical function defining M⁻¹ or by using a numerical technique (such as iterative processing) to obtain the required value.

The hyperbolic functions, tan h w and l/(cosh w) can be advantageously exploited by the mapping functions S(p) and C(p).

More particularly, since

$${( tanh w )}^{2} + {( \frac{1}{cosh w} )}^{2} = \frac{1 + {( sinh w )}^{2}}{{( cosh w )}^{2}} = 1$$

the mapping [tan h w, 1/(cosh w)] will put a point representing a value w on a unit semicircle.

For normalization purposes, it will be convenient to use a logarithmic transformation before performing the two hyperbolic transformations, tan h w and l/(cosh w), so that w=ln(p). In this case, a functional block diagram of a circular-mean calculator has a similar structure as that shown in FIG. 6. However, in this case, the nonlinear converters, SNL 503 and CNL 504, will perform the following mapping operations

S=tan h NP, CC=1/(cos h NP)

It is also possible to combine the logarithmic and hyperbolic transformations thereby simplifying the structure of the circular-mean calculator. Such a simplification can be achieved as follows.

If a hyperbolic transformation tan h(w) is preceded by a logarithmic transformation, w=ln(p), then

$$S ( p ) = tanh w = \frac{exp ( 2 w ) - 1}{exp ( 2 w ) + 1} = \frac{{p}^{2} - 1}{{p}^{2} + 1}$$

Since

$$C ( p ) = \sqrt{1 - {S}^{2} ( p )}$$

$$C ( p ) = \frac{2 p}{{p}^{2} + 1}$$

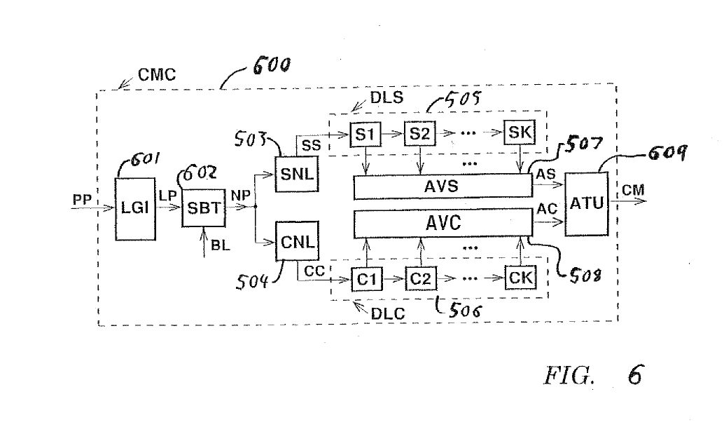

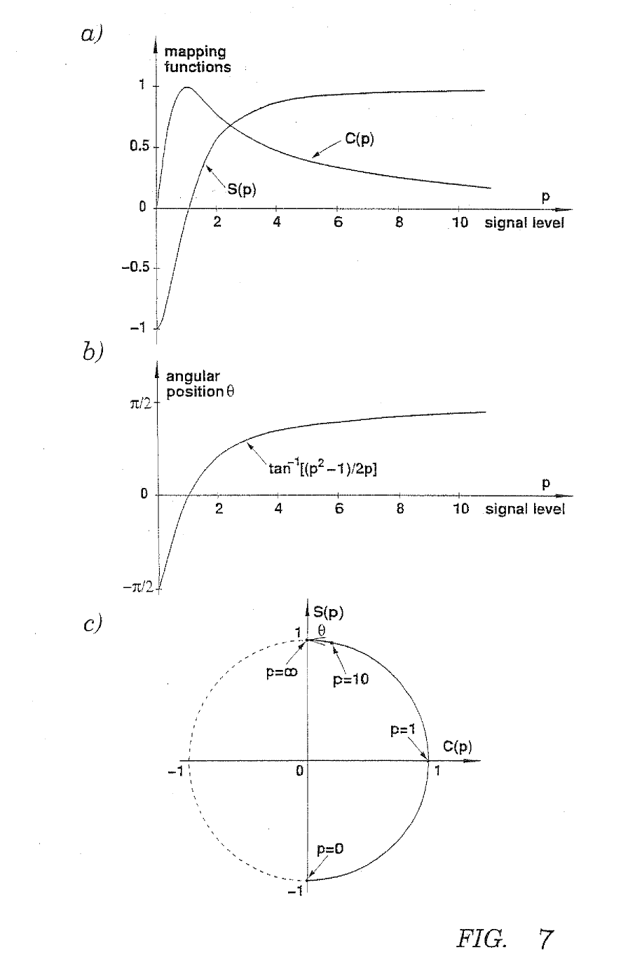

As shown in FIG. 7a and FIG. 7b, the shapes of the two mapping functions depict the relationship between signal values p and the corresponding angular positions θ of points representing the values on the unit semicircle. The relationship is non-linear, and its form of a ‘soft’ limiter results from its mathematical representation

θ=tan⁻¹[S(p)/C(p)]=tan⁻¹[(p²−1)/(2p)]

FIG. 7c shows the unit semicircle with angular positions θ corresponding to some selected underlying values p of the signal. As seen, for larger values (p>10) of the signal, the corresponding angular positions θ form a cluster close to the limiting value π/2; on the other hand, values of p less than unity generate angular positions θ occupying the whole quadrant (−π/2,0).

When the parameters Y_{K} and X_{K} have been determined from the observed values {p₁,p₂, . . . , p_{K-1},p_{K}} according to

$${Y}_{K} = \frac{1}{K} {\sum }_{k = 1}^{K} \frac{{p}_{k}^{2} - 1}{{p}_{k}^{2} + 1} ; {X}_{K} = \frac{1}{K} {\sum }_{k = 1}^{K} \frac{2 {p}_{k}}{{p}_{k}^{2} + 1}$$

the circular mean p_{CM} of the signal values p is obtained from

$${p}_{CM} = \frac{{Y}_{K}}{{X}_{K}} + \sqrt{{( \frac{{Y}_{K}}{{X}_{K}} )}^{2} + 1}$$

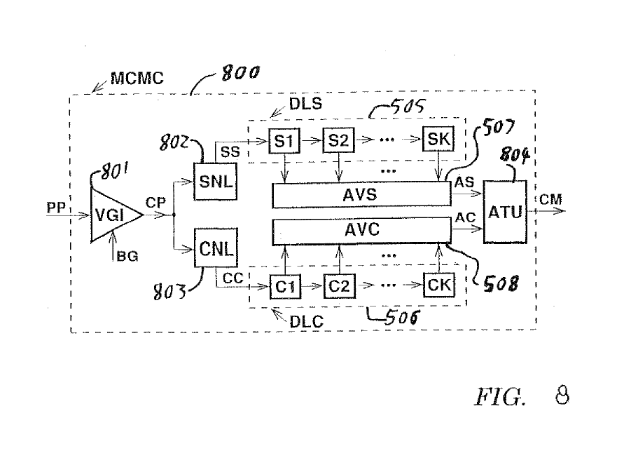

FIG. 8 is a functional block diagram of a modified circular-mean calculator MCMC 800 constructed in accordance with the third embodiment of the invention. In this configuration, the logarithmic converter LGI 601 and the subtractor SBT 602 used in the circular-mean calculator 600 of FIG. 6 have been replaced by a variable-gain amplifier VGI 801. The amplifier adjusts its gain in response to a signal BG indicative of the reference level of interest.

In this arrangement, the outputs, SS and CC, of the converters, SNL 802 and CNL 803, are obtained from the common input CP as follows

$$SS = \frac{{CP}^{2} - 1}{{CP}^{2} + 1} , CC = \frac{2 CP}{{CP}^{2} + 1}$$

Other functions and operations performed by the modified system are similar to those performed by the system of FIG. 6, and accordingly will not be described again here.

One of the intended applications of a circular-mean calculator, constructed in accordance with this embodiment of the invention, is the detection of signals in background noise. The following example illustrates such an application the embodiment. In the example, logarithmic and hyperbolic functions are exploited for mapping.

Assume that a random signal of unit power is to be detected in a noisy background comprising a unit-power thermal noise and impulsive interference with occasional spikes exceeding ten times the noise level. Assume also, for illustration purposes, that a detection threshold has been set to 1.9.

Suppose that in the no-signal case, six observed values of background noise are

p₁=p₂= . . . =p₅=1, p₆=10

The five equal samples may represent thermal noise level, and sample number six may be generated by impulsive interference. In this case, the arithmetic mean p_{AM} is equal to 2.5. Therefore, if the arithmetic mean p_{AM} were used as a detection statistic, a false alarm would be declared because the value 2.5 is greater than the detection threshold of 1.9.

Suppose now that the circular mean p_{CM}, rather than the arithmetic mean, is used to determine the level of background noise. The parameters Y₆ and X₆ are

$$6 \times {Y}_{6} = {\sum }_{k = 1}^{6} \frac{{p}_{k}^{2} - 1}{{p}_{k}^{2} + 1} \approx 1 , 6 \times {X}_{6} = {\sum }_{k = 1}^{6} \frac{2 {p}_{k}}{{p}_{k}^{2} + 1} \approx 5.2$$

Hence, the circular mean p_{CM} is

$${P}_{CM} = \frac{1}{5.2} + \sqrt{{( \frac{1}{5.2} )}^{2} + 1} \approx 1.2$$

As seen, in this case, the circular mean p_{CM} will not exceed the detection threshold, and hence, no false alarm will occur.

Suppose now that a random signal to be detected is present, and let six observed values, in this signal-plus-noise case, be all equal, for example, p₁=p₂= . . . =p₆=2. Obviously, in this case, both the arithmetic mean p_{AM} and the circular mean p_{CM} will be equal, p_{AM}=p_{CM}=2, and both will lead to a correct detection decision.

Therefore, the main advantage of utilizing the circular mean as a detection statistic follows from its ability to attenuate occasional larger observations. In general, such a property is very useful when processing signals corrupted by noise of impulsive nature.

### Fourth Embodiment

In accordance with a further embodiment of the invention, the circular concentration D_{CC} of points on the unit semicircle is calculated and used to set a detection threshold value against which the circular mean p_{CM} is compared and/or the circular concentration is used to adjust the value of the circular mean before it is compared with the detection threshold value.

The circular concentration D_{CC} of points {θₖ} that represent values {pₖ} of a signal level p is determined from

D_{CC}=\sqrt{X_{K}²+Y_{K}²}

where

$${Y}_{K} = \frac{1}{K} {\sum }_{k = 1}^{K} S ( {p}_{k} ) ; {X}_{K} = \frac{1}{K} {\sum }_{k = 1}^{K} C ( {p}_{k} )$$

and S(pₖ) and C(pₖ) are the two functions used for mapping.

The third embodiment is the most appropriate for calculating the values X_{K} and Y_{K} as these values are output by the initial mapping of the signal values p onto the semicircle in the third embodiment. However, it will be readily apparent to the skilled reader that X_{K} and Y_{K} may be calculated after mapping p onto the semicircle as in the first and second embodiments.

When the points {θ_{K}} farm a tight cluster on the semicircle, the value of the circular concentration D_{CC} will be close to one. However, when the points {θₖ} are widely dispersed, e.g., due to dominant noise, the value of the circular concentration D_{CC} will be significantly smaller. Accordingly, the circular concentration D_{CC} may be used in conjunction with the circular mean to further improve signal detection.

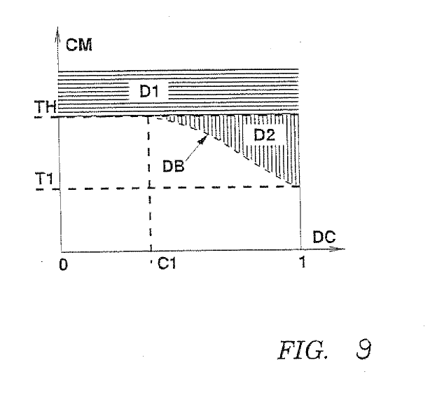

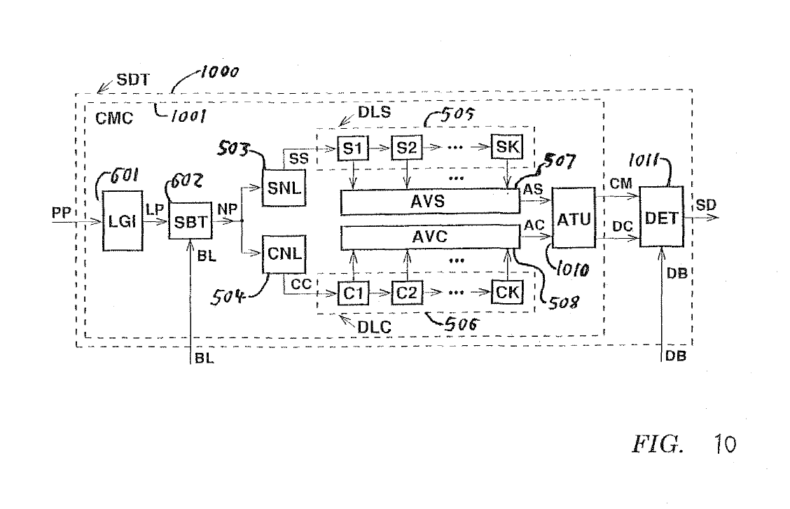

FIG. 9 illustrates a potential improvement in detection performance when the circular mean CM is suitably combined with the circular concentration DC to construct a detection-decision region.

When the circular mean CM alone is utilized for detection purposes, signal presence will be declared if an observed value of circular mean exceeds the decision threshold TH, irrespective of the circular concentration. In this case, the decision region D1 has a rectangular shape extending from the line TH.

However, when the circular mean CM is used in conjunction with the circular concentration DC, the resulting decision region will be augmented by the region D2. When circular concentration values exceed some predetermined threshold C1, the decision threshold TH for circular mean may be gradually reduced to a new lower value T1. Obviously, the area (D1+D2) is greater than the area D1 alone, and an improved detection performance will be achieved, when the threshold TH is replaced by a decision boundary DE.

FIG. 10 is a functional block diagram of a signal detector SDT 1000 constructed in accordance with a fourth embodiment of the invention which utilizes circular concentration to set the value of the detection threshold. The intended use of the signal detector SDT 1000 is the detection of small objects in sea clutter. Observed samples PP of background noise, or those of signal-plus-noise, are processed in the circular-mean calculator CMC 1001. The sample level is normalized by utilizing an auxiliary signal EL indicative of the average level of background noise. Such a signal may be obtained, for example, by averaging observations taken over a longer time interval and generated by a plurality of range cells adjacent to a cell under test.

The circular-mean calculator CMC 1001 provides two output signals, CM and DC, indicative respectively of the circular mean and circular concentration. Those signals are employed by a decision block DET 1011 to decide whether the observed samples PP have been generated by sea clutter alone or by an object buried in clutter. For this purpose a signal DB that defines the decision boundary is applied to input DB of the decision block DET 1011. The output signal SD of the block is the global decision regarding the presence or absence of a signal in clutter.

It should be noted that, in the embodiment described above, the circular concentration D_{CC} is used to adjust the threshold value against which the circular mean p_{CM} is compared (as shown in FIG. 9). However, this is equivalent to adjusting the value of the circular mean p_{CM} in dependence upon the circular concentration D_{CC} and comparing the adjusted mean against an unchanged threshold value. Accordingly, the embodiment may adjust p_{CM} instead of the threshold value. Similarly, both the threshold value and the circular mean p_{CM} may be adjusted in dependence upon the circular concentration D_{CC}.

Modifications and Variations

The foregoing description of preferred embodiments of the invention has been presented for the purpose of illustration and description. It is not intended to be exhaustive or to limit the invention to the precise form disclosed. In light of the foregoing description, it is evident that many alterations, modifications, and variations will enable those skilled in the art to utilize the invention in various embodiments suited to the particular use contemplated.

For example, in the embodiments described above, the signal values p are mapped to points on a semicircle. However, the use of a full semicircle is not essential and instead a circular arc smaller than a semicircle could be used. More particularly, the signal values p could be mapped to any circular arc subtending an angle of less than, or equal to, that subtended by a semicircular arc, namely π radians (or the equivalent, e.g. 180°).

In all of the embodiments described above, the mean direction θ_{MD} is calculated by determining both X_{K} (that is, the mean of the x coordinates of the points on the semicircle) and Y_{K} (that is, the mean of the y coordinates of the points on the semicircle) and then using both values to calculate θ_{MD}. However, although not as robust, it is not necessary to determine both X_{K} and Y_{K}, and instead of calculating the mean direction θ_{MD} an alternative mean M_{ALT} can be calculated as:

M_{ALT}=X_{K} or M_{ALT}=Y_{K}

More particularly, when the points p are mapped to a unit semicircle covering an angular range 0° to 180° or 180° to 360°, then M_{ALT}=X_{K} is used because the cosine values employed to calculate X_{K} have a unique value in this range. That is, there is a 1:1 mapping between the value of the point p on the semicircle with the x-axis. On the other hand, when the points p are mapped to a unit semicircle covering an angular range 90° to 270° or 270° to 90°, then M_{ALT}=Y_{K} is used because the sine value employed to calculate Y_{K} have a unique value in this range.

The alternative mean M_{ALT} can then be compared against a threshold or, if required, mapped back into the signal domain and compared against a threshold. For example, in the first and second embodiments, this mapping back may be performed using an inverse cosine mapping (in the case of M_{ALT}=X_{K}) or inverse sine mapping (in the case of M_{ALT}=Y_{K}) to map back to a point on the semicircle, and then applying an inverse mapping M⁻.

In the fourth embodiment described above, the circular mean p_{CM} is compared against a threshold set in dependence upon the circular concentration D_{CC} (or the circular mean p_{CM} is adjusted in dependence upon the circular concentration D_{CC}). However, instead, the mean direction θ_{MD} may be compared with a threshold set in dependence upon the circular concentration D_{CC} (or the mean direction θ_{MD} may be adjusted in dependence upon the circular concentration D_{CC}).

Other modifications are, of course, possible.

1. A signal processing method, comprising:
mapping each of a plurality of one-dimensional positive signal values representing the envelope, magnitude or power of the signal to a respective point on an arc of a circle in two-dimensional space, the two-dimensional space being defined by first and second coordinates on orthogonal axes and the arc subtending an angle which is less than, or equal to, the angle subtended by an arc of a semicircle;
calculating a mean value using the first and second coordinates of each mapped point on the arc; and
using the calculated mean value to determine whether the signal values exceed a threshold value by reverse-mapping the calculated mean value to a value in the signal domain, and comparing the reverse-mapped value with a threshold value.

2. A method according to claim 1, wherein the mean value is calculated by:
calculating a first mean value comprising a mean of the first coordinate values of the mapped points;
calculating a second mean value comprising a mean of the second coordinate values of the mapped points; and
calculating a mean direction in the two-dimensional space in dependence upon the first and second mean values.

3. A method according to claim 2, wherein each signal value is mapped to a point on the arc by:
mapping the signal value to a value representing an angle defining a point on the arc; and
calculating values of the first and second coordinates of the point by applying trigonometric functions to the angle.

4. A method according to claim 2, wherein each signal value is mapped to a point on the arc by applying a first function S(p) to the signal value to calculate a value for the first coordinate of the point on the arc and applying a second function C(p) to the signal value to calculate a value for the second coordinate of the point on the arc, such that the first and second functions satisfy the relationship S²(p)+C²(p)=b, where p is the signal value and b is a constant.

5. A method according to claim 4, wherein each of the first and second functions comprises a hyperbolic function.

6. A method according to claim 4, wherein each signal value is mapped to a point on the arc by:
applying a first function,
$$S ( p ) = \frac{{p}^{2} - 1}{{p}^{2} + 1} ;$$
and
applying a second function,
$$C ( p ) = \frac{2 p}{{p}^{2} + 1} .$$

7. (canceled)

8. A method according to claim 1, wherein:
a measure of the concentration of the mapped points on the arc is determined; and
the determined measure of the concentration is used to set the threshold value and/or to adjust the value of the mean to be compared against the threshold value.

9. A method according to claim 8, wherein the mean value is calculated by:
calculating a first mean value comprising a mean of the first coordinate values of the mapped points;
calculating a second mean value comprising a mean of the second coordinate values of the mapped points; and
calculating a mean direction in the two-dimensional space in dependence upon the first and second mean values, wherein the measure of the concentration of the mapped points on the arc is determined in dependence upon the first and second mean values in accordance with the equation:
Dcc=\sqrt{X_{K}²+Y_{K}²}
where D_{CC} is the measure of the concentration, X_{K} is the first mean value and Y_{K} is the second mean value.

10. A method according to claim 8, wherein the measure of the concentration is used to set the threshold value by:
comparing the measure of the concentration against a concentration threshold value; and
setting the threshold value in dependence upon the relationship between the measure of the concentration and the concentration threshold value by reducing a pre-set value when the measure of the concentration exceeds the concentration threshold value.

11. A signal processing apparatus, comprising:
a signal value mapper operable to map each of a plurality of one-dimensional positive signal values representing the envelope, magnitude or power of the signal to a respective point on an arc of a circle in two-dimensional space, the two-dimensional space being defined by first and second coordinates on orthogonal axes and the arc subtending an angle which is less than, or equal to, the angle subtended by an arc of a semicircle;
a mean value calculator operable to calculate a mean value using the first and second coordinates of each mapped point on the arc; and
a determining unit arranged to use the calculated mean value to determine whether the signal values exceed a threshold value,
wherein
the determining unit comprises a detecting unit having a reverse-mapper operable to reverse-map the calculated mean value to a value in the signal domain, and a comparer operable to compare the reverse-mapped value with a threshold value.

12. Apparatus according to claim 11, wherein the mean value calculator comprises:
a first coordinate mean value calculator operable to calculate a first mean value comprising a mean of the first coordinate values of the mapped points;
a second coordinate mean value calculator operable to calculate a second mean value comprising a mean of the second coordinate values of the mapped points; and
a mean direction calculator operable to calculate a mean direction in the two-dimensional space in dependence upon the first and second mean values.

13. Apparatus according to claim 12, wherein the signal value mapper is arranged to map each signal value to a point on the arc by:
mapping the signal value to a value representing an angle defining a point on the arc; and
calculating values of the first and second coordinates of the point by applying trigonometric functions to the angle.

14. Apparatus according to claim 12, wherein the signal value mapper is arranged to map each signal value to a point on the arc by applying a first function S(p) to the signal value to calculate a value for the first coordinate of the point on the arc and applying a second function C(p) to the signal value to calculate a value for the second coordinate of the point on the arc, such that the first and second functions satisfy the relationship S²(p)+C²(p)=b, where p is the signal value and b is a constant.

15. Apparatus according to claim 14, wherein the signal value mapper is arranged to map each signal value to a point on the arc by applying first and second functions each of which comprises a hyperbolic function.

16. Apparatus according to claim 14, wherein the signal value mapper is arranged to map each signal value to a point on the arc by:
applying a first function,
$$S ( p ) = \frac{{p}^{2} - 1}{{p}^{2} + 1} ;$$
and
applying a second function,
$$C ( p ) = \frac{2 p}{{p}^{2} + 1} .$$

17. (canceled)

18. Apparatus according to claim 11, wherein:
the apparatus further comprises a concentration measure calculator operable to calculate a measure of the concentration of the mapped points on the arc; and
the determining unit is arranged to perform processing comprising at least one of using the determined measure of the concentration to set the threshold value, and adjusting the value of the mean to be compared against the threshold value.

19. Apparatus according to claim 18, wherein the mean value calculator comprises:
a first coordinate mean value calculator operable to calculate a first mean value comprising a mean of the first coordinate values of the mapped points;
a second coordinate mean value calculator operable to calculate a second mean value comprising a mean of the second coordinate values of the mapped points; and
a mean direction calculator operable to calculate a mean direction in the two-dimensional space in dependence upon the first and second mean values, wherein the concentration measure calculator is arranged to calculate the measure of the concentration of the mapped points on the arc in dependence upon the first and second mean values in accordance with the equation:
Dcc=\sqrt{X_{K}²+Y_{K}²}
where D_{CC} is the measure of the concentration, X_{K} is the first mean value and Y_{K} is the second mean value.

20. Apparatus according to claim 18, wherein the concentration measure calculator is arranged to set the threshold value using the measure of the concentration by:
comparing the measure of the concentration against a concentration threshold value; and
setting the threshold value in dependence upon the relationship between the measure of the concentration and the concentration threshold value by reducing a pre-set value when the measure of the concentration exceeds the concentration threshold value.
